(19) United States
(12) Patent Application Publication
(10) Pub. No.: US 2017/0328738 A1
(43) Pub. Date: Nov. 16, 2017

(54) Magnetic Alarm System

(71) Applicant: Diodes Incorporated, Plano, TX (US)

(72) Inventor: Ying-Tang Cho, Zhu-Bei City (TW)

(73) Assignee: Diodes Incorporated, Plano, TX (US)

(21) Appl. No.: 15/152,596

(22) Filed: May 12, 2016

(51) Int. Cl. G01D 5/14

(52) U.S. Cl. CPC G01D 5/145

(57) ABSTRACT

A security system comprises a Hall sensor, two comparators, and a logic unit. The system takes periodic measurement of the magnetic field in the vicinity of the Hall sensor and compares the measured voltage to two known references voltages. When the measured voltage is outside the range defined by the reference voltages, the system triggers an alarm.

### BACKGROUND

Conventional alarm systems for doors and such use Reed switches or Hall sensors to detect unauthorized attempt to gain access.

Reed switch is basically a magnetic-force-activated single pole single throw mechanical switch that operates either in default-on or in default-off mode. In the default-off mode, the switch stays open as long as the controlling magnetic force is stronger than a threshold value, and closes to trigger an alarm when the magnetic force is weaker than the threshold, such as when an unauthorized opening is attempted.

In a typical door security system, a Reed switch is affixed on the door frame and a magnet is affixed to the door and in close vicinity of the Reed switch when the door is closed. The magnet exerts a fixed magnetic force on the default-off mode switch to force it to be in an open position. When the door is being opened, the magnet moves away from the Reed switch and the magnetic force exerted on the switch is thus weakened. When the magnetic force at the switch is weaker than a threshold value, the switch closes to trigger an alarm.

A default-on Reed switch operates in an opposite manner—it stays closed by the force of the magnetic field and opens when the magnetic field is weakened beyond the threshold value.

Due to inherent fragility of the Reed switch type security system both mechanically and electrically, the Reed switch system has been replaced with solid state Hall sensor system in more critical security systems. The Hall sensor generates a voltage signal corresponding to the strength of the magnetic field that asserted on it. The system works to detect unauthorized attempts to open the secured door in the same principle as the Reed switch system—when the magnetic field at the Hall sensor falls below a preset threshold value, indicting such an attempt, the system triggers an alarm

### SUMMARY OF THE INVENTION

The Hall sensors are less fragile then the Reed switches and thus more reliable. However, the Inventor recognized that even with a Hall sensor, conventional alarm systems can be vulnerable to tempering—such as with a second magnet and a compass.

The cause of vulnerability comes from the fact that such a security system only looks out for the falling of the magnetic field below the threshold and is subject to sabotage by someone with a second magnet aligned properly with the system magnetic (with the aid of a compass) to artificially enhance the magnetic field to the Hall sensor. With such a second magnet in place, unauthorized person can open the door and escape detection.

With this recognition, the Inventors endeavored to invent a novel security system that overcomes the deficiency of the conventional systems. This new system not only is sensitive to the falling the magnetic field but also to the rising of the magnetic field at the sensor location. By sensing both the falling and the rising of the magnetic field, this novel system, which can be implemented with a single magnetic sensor such as a Hall sensor and a magnet, can detect when someone opens the secured door as well as when someone attempts to circumvent the security system such as with external magnets.

This invention may be implemented cost effectively with, for example, a Hall sensor, two comparators, and a logic unit. The system takes periodic measurement of the magnetic field and compares the measured voltage to two known references voltages. When the measured voltage is outside the range defined by the reference voltages, the system through the logic unit will output an alarm trigger signal.

### BRIEF DESCRIPTION OF DRAWINGS

FIG. 1 depicts a schematic block diagram of a security system that embodies some aspects of this invention.

FIG. 2 depicts an exemplary implementation of a logic circuit.

FIG. 3 depicts the transfer function of the logic circuit in FIG. 2.

### DETAILED DESCRIPTION OF EXEMPLARY EMBODIMENTS

### Definition of Terms

The terms used in this disclosure generally have their ordinary meanings in the art within the context of the invention. Certain terms are discussed below to provide additional guidance to the practitioners regarding the description of the invention. It will be appreciated that same thing can be said in more than one way. Consequently, alternative language and synonyms may be used.

A Hall sensor in the context of this invention means a semiconductor device that, when subject to a properly aligned magnetic field, generates a voltage at its output terminals. The generated voltage, especially when the Hall sensor is integrated in an integrated circuit chip may be amplified for further process

In the context of this invention, a BOP means a magnetic field point of operation. The disclosed exemplary systems incorporate two different BOPs—one represents a lower-threshold magnetic field and the other represents an upper-threshold magnetic field. The two different BOPs are of the same polarity—that is, both of them may be positive or negative; but they have different values.

A reference voltage in the context of this invention means a fixed and constant voltage. In the disclosed exemplary systems, two reference voltages are selected to correspond to the two different BOPs—one to the upper-threshold magnetic field and the other to the lower-threshold magnetic field.

In the context of this invention, a measured voltage means a voltage that is generated from a Hall sensor. If the generated voltage is too weak, it will be amplified and the measured voltage is the voltage after amplification. The amplifier may be incorporated with the Hall sensor in an integrated circuit chip

In the context of this invention, a single-bit signal is a signal expressed as logic high or logic low; or logic one or logic zero.

The logic circuit in the context of this invention performs a logic function and may be implemented with hardware logic elements; or with software instructions executable by processors or computers.

An alarm triggering signal in the context of this invention may be a signal that actually triggers a physical alarm; or it may be a signal to record an occurrence of an predetermined event detected by the systems.

When two signals are in the opposite logic states in the context of this invention, one of the signals is represented as a logic one and the other signal is represented as a logic zero. When they are in the same logic state, both may be logic one or logic zero.

### Detail Description of Embodiments

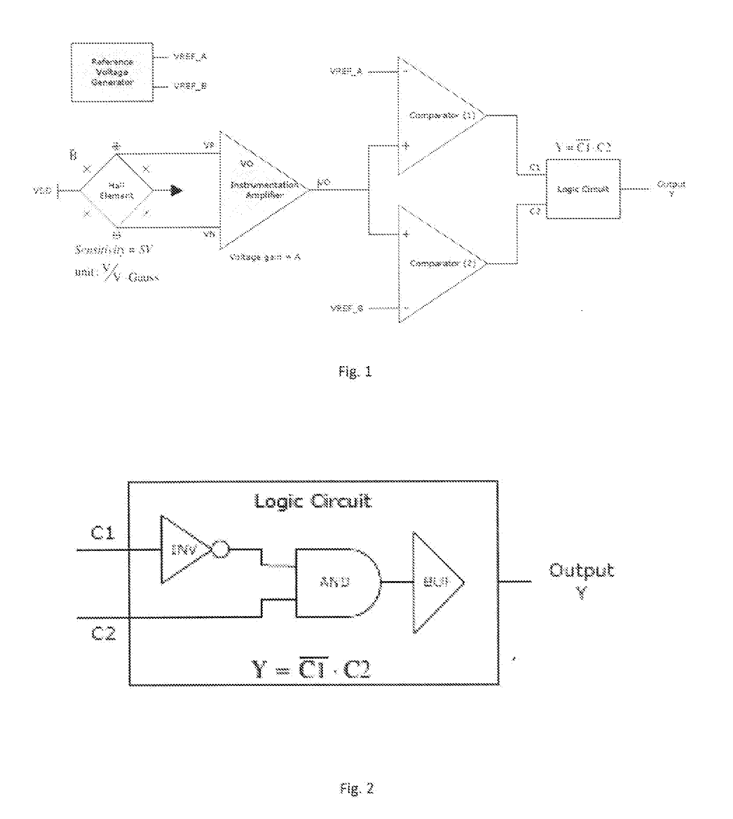

FIG. 1 depicts the schematic block diagram of a security system 100 that embodies some aspects of this invention. System 100 comprises a Hall sensor 101, an instrumentation amplifier 102, two comparators 103 and 104, and a logic circuit 105.

In this system Hall sensor 101 is a semiconductor Hall sensor that is a part of an integrated chip that also includes an amplifier. In other systems that embodied this invention, the Hall sensor and the amplifier may be built as stand-alone devices. The Hall sensor as depicted is a four-terminal device. External power in the form of an electric current is supplied between two of the terminals and an electrical voltage signal appears between the other two terminals when the sensor senses a magnetic field that has a component perpendicular to the direction of the current flow. The magnitude of the voltage signal is a function of the current and the magnetic field.

To boost the voltage from the Hall sensor, an amplifier 102 is included in the system and is depicted in FIG. 1 following the Hall sensor 101. The output of the amplifier 102 is designated as the measured signal.

The output from the Hall sensor followed by the amplifier is an analog signal. Its magnitude and the polarity correspond to the magnitude and the polarity of the magnetic field sensed by the Hall sensor. In the security system depicted in FIG. 1, the source of the magnetic field may be a permanent magnet or an electromagnet.

When the exemplary security system is installed on, for example, a closed door with a magnet affixed on the door and the Hall sensor affixed to the door frame, the predetermined distance between the magnet and the sensor is fixed. Knowing this distance and the strength of the magnet, the magnetic field at the sensor and consequently the measured voltage signal at the output of the amplifier 102 are also discemible.

When someone attempts to breach this security system either by force the door open or by disturbing the magnetic field such as an extra magnet, the Hall sensor will sense the change in the magnetic field. When the door is forced open, the distance between the magnet and the Hall sensor increases and magnetic field sensed by the Hall sensor will decrease. When an extra magnet approaches the magnet in the security system the magnetic field sensed by the Hall sensor will be either enhanced if the poles of two magnets are aligned or reduced if the poles are opposite to each other.

The security system 100 sets a limit to the allowed deviation of the magnetic field sensed by the Hall sensor 101. When the measured voltage signal goes outside of either the upper and lower limit of allowed deviation, the system will generate a signal that can be used to trigger an alarm indicating that a breach is being attempted.

In this system the upper and the lower limits are set with a reference voltage generator 106. In its simplest form, a reference voltage generator may comprise a constant current source and a resistor divider and can be incorporated within the integrated circuit chip of the Hall sensor 101 and the amplifier 102. More sophisticated reference voltage generators may involve compensation for temperature, load condition, and other external factors. Reference voltage generator 106 generates two reference voltages—V_{REF}_{_}A and V_{REF}_{_}B, which correspond to the upper limit and the lower limit of the allowed magnetic field deviation respectively.

The two reference voltages and the measured voltage signal are conveyed to two comparators 103 and 104, where the measured voltage signal is compared to the V_{REF}_{_}A and V_{REF}_{_}B separately. When the door is secure, the measured voltage signal will stay between V_{REF}_{_}A and V_{REF}_{_}B. One comparator will output a logic 1 and the other comparator will output a logic 0 as the result of the comparison.

When the measured voltage signal is greater than the upper limit, both comparators as depicted in FIG. 1 will output a logic 1. This is an indication that an external magnetic source is being placed near the system magnet. When the measured voltage signal is smaller than the lower limit, both comparators will output logic 0. This is an indication that either the door is being force open or that an external means, such as a magnet, is subtracting the magnetic field of the system magnet. When anyone of the above conditions is detected and the measured voltage signal is outside the range of V_{REF}_{_}A and V_{REF}_{_}B, the security system 100 generates an alarm triggering signal.

FIG. 2 depicts the schematic diagram of an exemplary logic circuit 200, which when coupled to the two comparators as depicted in FIG. 1, can perform the task of generating an alarm triggering signal.

The logic circuit 200 comprises the following logic elements: an inverter 201, an AND gate 202, and a buffer 203. The input to the inverter 201 is from one of the comparators, e.g. 104; the output from the inverter is coupled to one input terminal of the AND gate 202. The other input terminal of the AND gate 202 is coupled to the output of the second comparator, e.g. 103. The output of the AND gate 202 is fed to the buffer 203 and the output of the buffer 203 is the designated alarm triggering signal.

In mathematical and logic terms, the function of this exemplary logic circuit can be expressed as follows

Y=C̅1̅·C2

where C1 and C2 are outputs from the two comparators respectively; and Y is the logic product of C2 and reverse C1, and the output of the logic circuit 200.

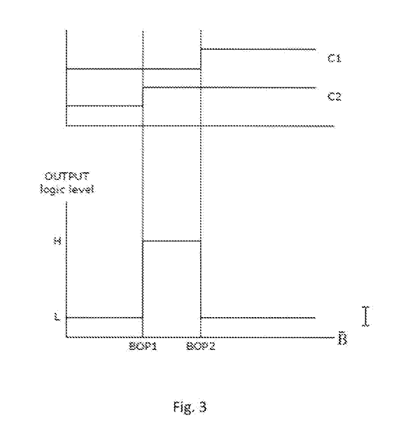

The logic circuit 200 is only one exemplary circuit that fulfills the required function of the logic circuit 105 depicted in FIG. 1. A person skilled in logic circuit design can design other logic circuits that perform the same logic function. Microprocessors and computers can also be programmed with software instructions to achieve the same purpose. The transfer function of the logic circuit 200 is further depicted in FIG. 3.

FIG. 3a depicts the output signals 301 and 302 from the two comparators 103 and 104 that feed into the two input terminals of the logic circuit 200; and FIG. 3b depicts the output signal 303 from the logic circuit 200. BOP1 and BOP2 on the abscissa designate the two threshold values—the lower and the upper limit set for the security system and correspond to the reference voltages V_{REF}_{_}A and V_{REF}_{_}B from the reference voltage generator 106.

When the measured voltage signal from the amplifier 102 has a value that is between V_{REF}_{_}A and V_{REF}_{_}B, indicating that the door protected by the security system is secure, the outputs from the two comparators are between BOP1 and BOP2 and in opposite logic states, as shown in the region 310. Correspondingly, the output Y from the logic circuit 200 outputs a logic high or logic 1 signal.

Outside the region of BOP1 and BOP2, however, the outputs of the two comparators are in the same logic states; and that causes the logic circuit to issue a logic low or logic 0 signal, which is an alarm triggering signal indicating the detection of a security breach.

1. A system, comprising
a first reference voltage and a second reference voltage;
a first comparator configured to compare a measured voltage to the first reference voltage and to output a first one-bit signal based on the comparison;
a second comparator configured to compare the measured voltage to the second reference voltage and to output a second one-bit signal based on the comparison; and
a logic circuit configured to output an alarm triggering signal when the first one-bit signal and the second one-bit signal are not in opposite logic states.

2. The system of claim 1, in which the measured voltage is an output of a Hall sensor and an amplifier.

3. The system of claim 2, further comprising a magnet disposed in the vicinity of the Hall sensor.

4. A method, comprising
comparing a measured voltage to a first reference voltage and generating a first one-bit signal based on the comparison;
comparing the measured voltage to a second reference voltage and generating a second one-bit signal based on the comparison; and
generating an alarm triggering signal when the first one-bit signal and the second one-bit signal are not in opposite logic states.

5. The method of claim 4, in which the measured voltage is generated from a Hall sensor and an amplifier.

6. A method, comprising
measuring a magnetic field and generating a voltage signal based on the measurement; and
generating an alarm triggering signal when the voltage signal is smaller than a first reference voltage and a second reference voltage or when the voltage signal is greater than the first reference voltage and the second reference voltage.

7. The method of claim 6, in which the measured voltage signal is generated by a Hall sensor

8. A alarm system, comprising
a device configured for measuring a magnetic field and generating a voltage signal based on measurement; and
a logic circuit configured for generating an alarm triggering signal when the measure voltage signal is smaller than both a first reference voltage and a second reference voltage or when the measured voltage signal is greater than both the first reference voltage and the second reference voltage.

9. A system comprising
a logic circuit configured to generate an alarm triggering signal when a measured voltage generated by a Hall sensor is smaller than a first reference voltage and a second reference voltage or greater than the first reference voltage and the second reference voltage.
